(19) United States
(12) Patent Application Publication
(10) Pub. No.: US 2012/0105577 A1
(43) Pub. Date: May 3, 2012

(54) PANORAMIC IMAGE GENERATION DEVICE AND PANORAMIC IMAGE GENERATION METHOD

(75) Inventor: Seiichiro Sakata, Tokyo (JP)

(73) Assignee: OLYMPUS IMAGING CORP., Tokyo (JP)

(21) Appl. No.: 13/285,618

(22) Filed: Oct. 31, 2011

(30) Foreign Application Priority Data
Nov. 1, 2010 (JP) 2010-245195

(51) Int. Cl. H04N 5/225

(52) U.S. Cl. 348/36; 348/E05.024

(57) ABSTRACT

A panoramic image generation device generates a panoramic image by synthesizing a plurality of static images constituting the moving image, determines a size at which a display panoramic image is to be cut out from the panoramic image, and detects a focus photography position from the panoramic image. The panoramic image generation device cuts out the display panoramic image from the panoramic image on the basis of the detected focus photography position and the determined size.

### FIELD OF THE INVENTION

This invention relates to a technique for generating a panoramic image from a moving image.

### BACKGROUND OF THE INVENTION

Conventional techniques for generating a panoramic image from a plurality of static images constituting a moving image are known (see JP2009-141821A, JP2000-244814A, JP2009-159514A).

### SUMMARY OF THE INVENTION

A panoramic image generation device capable of generating a panoramic image from a moving image includes a panoramic image generation unit that generates the panoramic image by synthesizing a plurality of static images constituting the moving image, a cutout size determination unit that determines a size at which a display panoramic image is to be cut out from the panoramic image generated by the panoramic image generation unit, a focus photography position determination unit that detects a focus photography position from the panoramic image generated by the panoramic image generation unit, a display panoramic image cutout unit that cuts out the display panoramic image from the panoramic image generated by the panoramic image generation unit on the basis of the focus photography position detected by the focus photography position determination unit and the size determined by the cutout size determination unit, and a display unit that displays the display panoramic image cut out by the display panoramic image cutout unit.

A panoramic image generation method for generating a panoramic image from a moving image includes a step of generating the panoramic image by synthesizing a plurality of static images constituting the moving image, a step of determining a size at which a display panoramic image is to be cut out from the generated panoramic image, a step of detecting a focus photography position from the generated panoramic image, and a step of cutting out the display panoramic image from the panoramic image on the basis of the detected focus photography position and the determined size.

### BRIEF DESCRIPTION OF THE DRAWINGS

These and other features, aspects, and advantages of the apparatus and methods of the present invention will become better understood with regard to the following description, appended claims, and accompanying drawings.

FIG. 1 is a front perspective view showing a digital camera installed with a panoramic image generation device according to an embodiment.

FIG. 2 is a back perspective view of the digital camera installed with the panoramic image generation device according to this embodiment.

FIG. 3 is a view showing an example of a hardware configuration of the digital camera.

FIG. 4 is a flowchart showing a flow of processing performed to generate the cutout panoramic image from the panoramic image generated by an image synthesis unit and display the generated cutout panoramic image on a display unit.

FIG. 5 is a flowchart showing a flow of processing of generating a cutout panoramic image from a portrait shaped panoramic image.

FIG. 6 is a view showing examples of a plurality of static images constituting a moving image, which are used to generate a panoramic image.

FIG. 7 is a view showing an example of a panoramic image generated on the basis of the plurality of static images constituting a moving image shown in FIG. 6.

FIG. 8 is a view illustrating a method of calculating the latitudinal direction cutout amount to be applied to a panoramic image generated by the image synthesis unit.

FIG. 9 is a view showing center positions of a plurality of static images used to generate a panoramic image, relating to the panoramic image generated by the image synthesis unit.

FIG. 10 is a view showing coordinates on a temporal axis of the center positions of the plurality of static images constituting the panoramic image.

FIG. 11 is a graph showing the number of static image center positions per unit section in the latitudinal direction of the panoramic image, and a view showing a focus position of the panoramic image.

FIG. 12 is a view showing an example of the cutout panoramic image generated from the moving image shown in FIG. 6 and displayed on the display unit.

FIG. 13 is a flowchart showing a flow of processing for displaying a moving image using static images included in the cutout panoramic image.

FIG. 14 is a view showing examples of frames included in the cutout panoramic image.

FIG. 15 is a view showing an example in which the frames included in the cutout panoramic image shown in FIG. 14 are reproduced in sequence as a moving image.

FIG. 16 is a view showing an example in which a cutout panoramic image is displayed simultaneously during reproduction of a moving image in the form of a digest.

FIG. 17 is a view showing an example in which a time bar is displayed additionally in the moving image reproduction method described using FIG. 16.

FIG. 18 is a view showing an example in which the cutout panoramic image displayed on the display unit also moves.

### DETAILED DESCRIPTION OF THE PREFERRED EMBODIMENT

Preferred embodiment of the invention is described below with reference to the accompanying drawings.

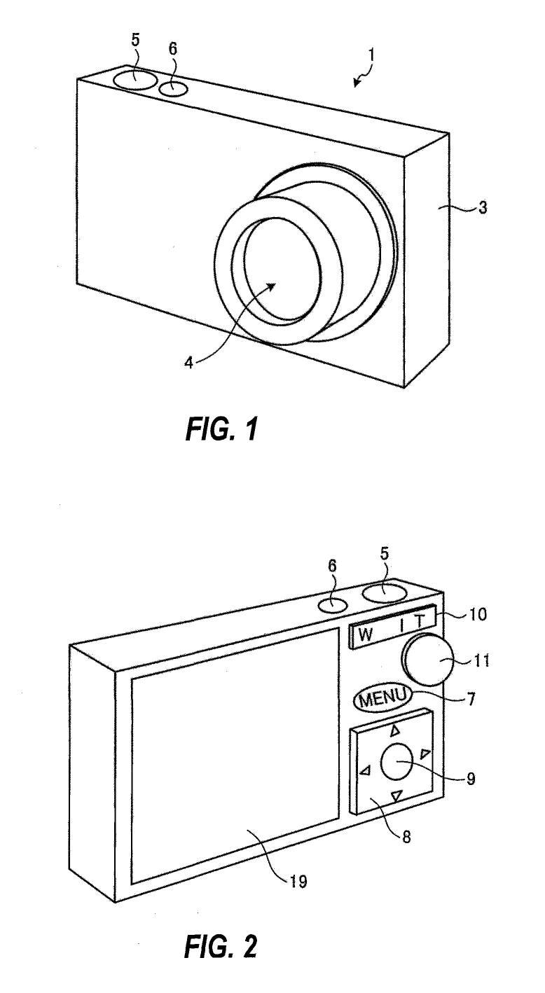

FIG. 1 is a front perspective view showing a digital camera 1 installed with a panoramic image generation device according to an embodiment. FIG. 2 is a back perspective view of the digital camera 1 installed with the panoramic image generation device according to this embodiment.

As shown in FIGS. 1 and 2, the digital camera 1 includes a camera main body 3 formed in a substantially rectangular parallelepiped shape, a lens 4 serving as an optical system, a shutter button 5, a power button 6 (see FIG. 1 for the above components), a menu button 7, a cross button 8, an OK/FUNC button 9, a zoom button 10, and a mode dial 11, which serves as operating units, and a display unit 19 such as a liquid crystal monitor (see FIG. 2 for the above components).

The shutter button 5 is an operating button for instructing recording of a static image and a moving image (consecutive static images) photographed via the lens 4. The power button 6 is an operating button for switching a power supply of the digital camera 10N and OFF. The menu button 7 is an operating button for displaying a menu screen on which various settings can be performed in relation to the digital camera 1 on the display unit 19.

The cross button 8 is an operating button for selecting a desired menu item by moving a position of a cursor on the menu screen displayed on the display unit 19 or the like. The OK/FUNC button 9 is an operating button for confirming the menu item selected using the cross button 8 as a selected item.

The zoom button 10 is an operating button for instructing modification of a focal length by moving the lens 4 to a wide angle side or a telephoto side. The mode dial 11 is an operating dial for setting an operating mode of the digital camera 1, such as a moving image photography mode or a static image photography mode, for example.

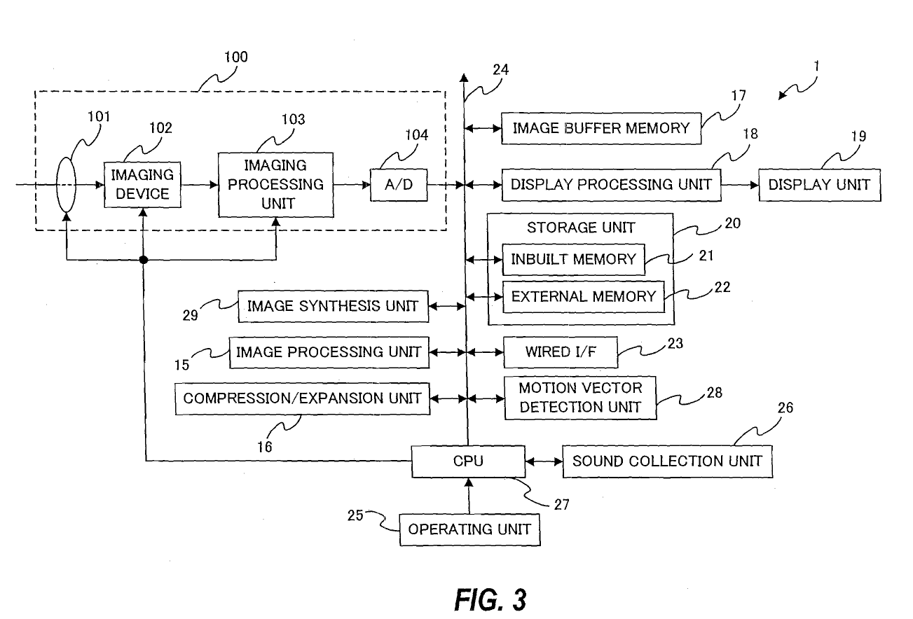

FIG. 3 is a view showing an example of a hardware configuration of the digital camera 1. The digital camera 1 shown in FIG. 3 includes a lens 101 (corresponding to the lens 4 in FIG. 1), an imaging device 102, an imaging processing unit 103, an A/D 104 (components from the lens 101 to the A/D 104 will be referred to as an “imaging unit 100”), an image processing unit 15, a compression/expansion unit 16, an image buffer memory 17, a display processing unit 18, a display unit 19 (corresponding to the display unit 19 in FIG. 2), a storage unit 20, an inbuilt memory 21, an external memory 22, a wired I/F 23, a bus 24, an operating unit 25, a sound collection unit 26, a CPU 27, a motion vector detection unit 28, an image synthesis unit 29, and so on.

The imaging unit 100 photographs an object and generates image data (image signals) sequentially. The generated image data are output to the image buffer memory 17 via the bus 24. As described above, the imaging unit 100 is constituted by the lens 101, the imaging device 102, the imaging processing unit 103, and the A/D 104.

The lens 101 forms an object image obtained when the object is photographed on the imaging device 102. The imaging device 102 outputs an analog electric signal that represents an image obtained by subjecting the object image formed by the lens 101 to photoelectric conversion to the imaging processing unit 103. The imaging device 102 is a CCD (Charge Coupled Device), for example.

The imaging processing unit 103 reduces a noise component and stabilizes a signal level of the analog electric signal output from the imaging device 102, and outputs the resulting signal to the A/D 104. The imaging processing unit 103 includes circuits such as a CDS (Correlated Double Sampling) circuit for reducing the noise component of the analog electric signal and an AGC (Automatic Gain Control) circuit for stabilizing the signal level of the analog electric signal. The A/D 104 converts the analog electric signal output from the imaging processing unit 103 into a digital electric signal. The converted digital electric signal is output to the bus 24 as the image data.

The image buffer memory 17 temporarily stores the image data output from the A/D 104 and input via the bus 24. The image buffer memory 17 is a storage device such as a DRAM (Dynamic Random Access Memory), for example.

The image processing unit 15 implements various types of image processing, for example correction processing such as gamma correction and white balance correction, and enlargement/reduction processing (resizing processing) for increasing or reducing a pixel count, on the image data stored in the image buffer memory 17, the inbuilt memory 21, or the external memory 22. The image processing unit 15 implements the above image processing as preprocessing on the basis of the image data stored in the image buffer memory 17, the inbuilt memory 21, or the external memory 22 when the image data are to be displayed on the display unit 19 or when the image data stored in the image buffer memory 17 are to be stored in the inbuilt memory 21 or the external memory 22.

The compression/expansion unit 16 implements compression processing when the image data subjected to image processing by the image processing unit 15 are stored in the inbuilt memory 21 or the external memory 22, and implements expansion processing when the image data stored in the inbuilt memory 21 or the external memory 22 are read. Here, the compression processing and expansion processing are based on the JPEG (Joint Photographic Experts Group) system, the MPEG (Moving Picture Experts Group) system, or similar, for example.

The display processing unit 18 generates a video signal that can be displayed by the display unit 19 on the basis of the image data subjected to image processing by the image processing unit 15 and outputs the generated video signal to the display unit 19 when the image data are to be displayed on the display unit 19. The display unit 19 displays a video corresponding to the video signal output from the display processing unit 18. The display unit 19 is a display device such as a liquid crystal monitor, for example.

The storage unit 20 stores the image data. Here, the image data denote image data subjected to image processing by the image processing unit 15 and compression processing by the compression/expansion unit 16. The storage unit 20 is constituted by the inbuilt memory 21 and the external memory 22. The inbuilt memory 21 is a memory built into the digital camera 1 in advance. The external memory 22 is a memory card that can be attached to and detached from the digital camera 1 freely, for example an xD-picture card (registered trademark).

The wired I/F 23 is an interface for connecting the digital camera 1 to an external device by a wired communication standard. The wired communication standard is a USB (Universal Serial Bus), for example.

The operating unit 25 is constituted by the shutter button 5 and power button 6 shown in FIG. 1, the menu button 7, the cross button 8, the OK/FUNC button 9, the zoom button 10, the mode dial 11, and so on. Operating information relating to the operating unit 25 is transmitted to the CPU 27. The sound collection unit 26 is a device such as a microphone for collecting sound. An audio signal obtained by the sound collection unit 26 is transmitted to the CPU 27.

The CPU (also referred to as a cutout size determination unit, a focus photography position determination unit, a display panoramic image cutout unit, and a reproduction unit) 27 controls an overall operation of the digital camera 1 by reading and executing a control program stored in the inbuilt memory 21 of the storage unit 20.

The motion vector detection unit 28 detects a motion vector between a plurality of images using a known method.

The image synthesis unit (also referred to as a panoramic image generation unit) 29 generates a synthesized image by correcting positional deviation between a plurality of images on the basis of the motion vector detected by the motion vector detection unit 28 and synthesizing the plurality of images subjected to the positional deviation correction. In particular, the image synthesis unit 29 generates a panoramic image by correcting positional deviation between a plurality of static images constituting a moving image and synthesizing the plurality of static images subjected to the positional deviation correction. A method of generating a panoramic image from a plurality of static images constituting a moving image is well known, and therefore detailed description of processing for generating a panoramic image will be omitted here.

In the digital camera installed with the panoramic image generation device according to this embodiment, an image region on which a user focuses during moving image photography is cut out of the panoramic image generated by the image synthesis unit 29 and displayed on the display unit 19 as a new panoramic image. The new panoramic image generated by cutting the panoramic image generated by the image synthesis unit 29 will be referred to here as a cutout panoramic image.

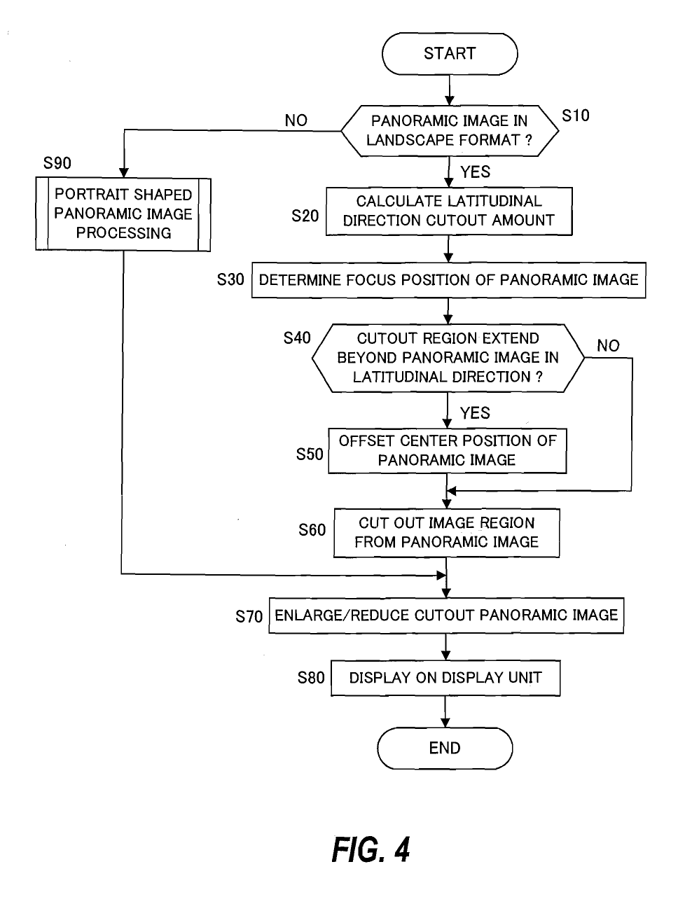

FIG. 4 is a flowchart showing a flow of processing performed to generate the cutout panoramic image from the panoramic image generated by the image synthesis unit 29 and display the generated cutout panoramic image on the display unit 19. The processing starting from a step S10 is performed by the CPU 27. It should be noted, however, that a part of the processing in the respective steps of the flowchart may be performed by the image processing unit 15. Alternatively, a GPU (Graphics Processing Unit), not shown in the figures, may be provided and a part of the processing may be performed thereby.

In the step S10, a determination is made as to whether or not the panoramic image generated by the image synthesis unit 29 is in landscape format.

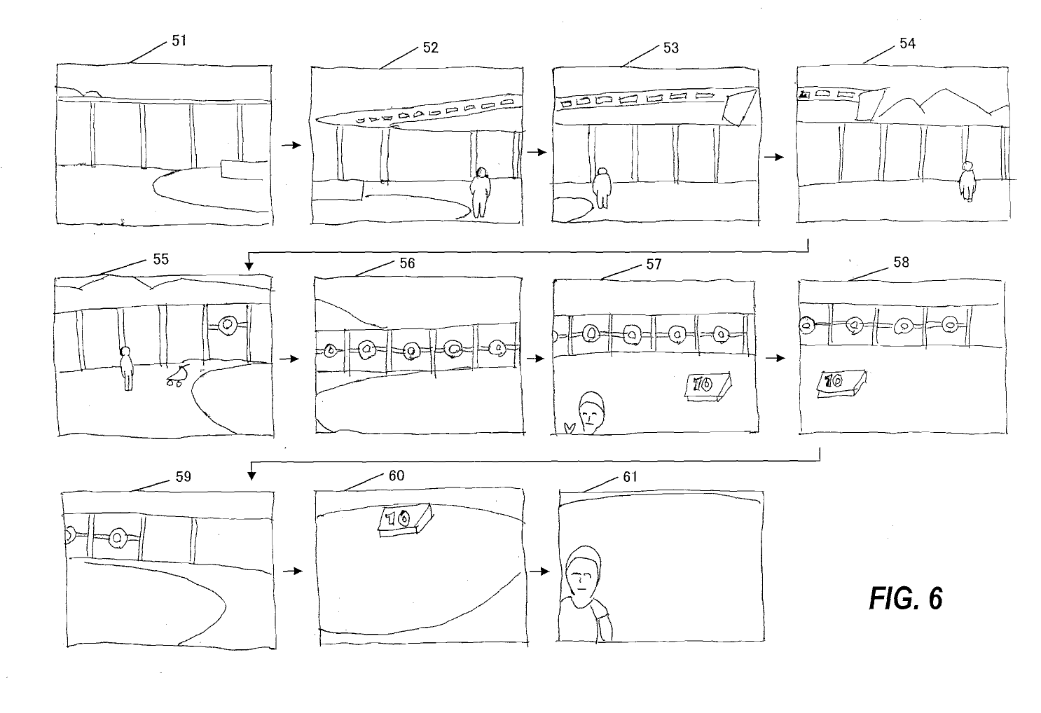

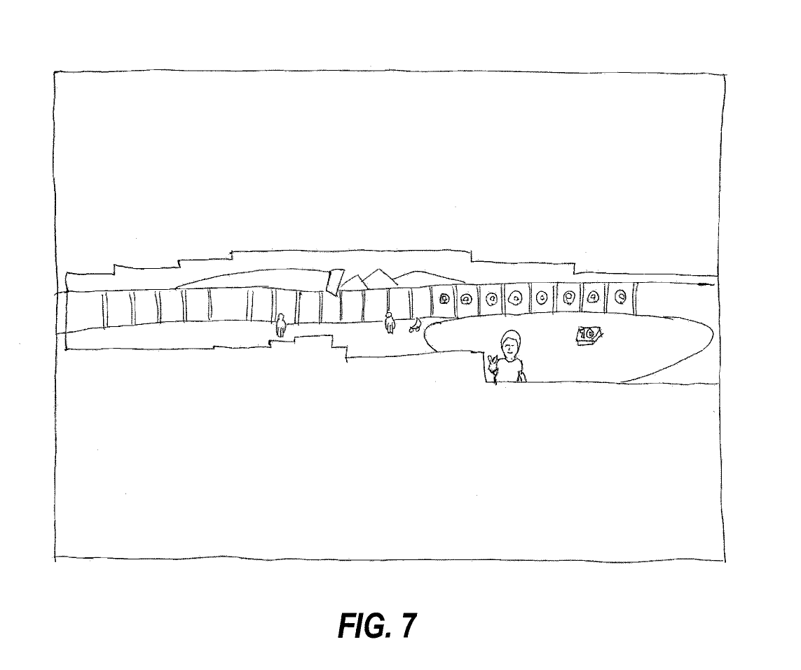

FIG. 6 is a view showing examples of a plurality of static images 51 to 61 constituting a moving image, which are used to generate a panoramic image. Further, FIG. 7 is a view showing an example of a panoramic image generated on the basis of the plurality of static images 51 to 61 constituting a moving image shown in FIG. 6.

When the camera lens is moved mainly in a latitudinal direction, as shown in FIG. 6, during moving image photography, the generated panoramic image is in landscape format, as shown in FIG. 7. When the camera lens is moved mainly in a longitudinal direction during moving image photography, on the other hand, the generated panoramic image is in portrait format.

When it is determined in the step S10 that the generated panoramic image is in landscape format, the routine advances to a step S20. Processing from the step S20 to a step S60 is processing performed in relation to a landscape format panoramic image.

In the step S20, a latitudinal direction (horizontal direction) cutout amount (cutout size) to be applied to the panoramic image generated by the image synthesis unit 29 is calculated.

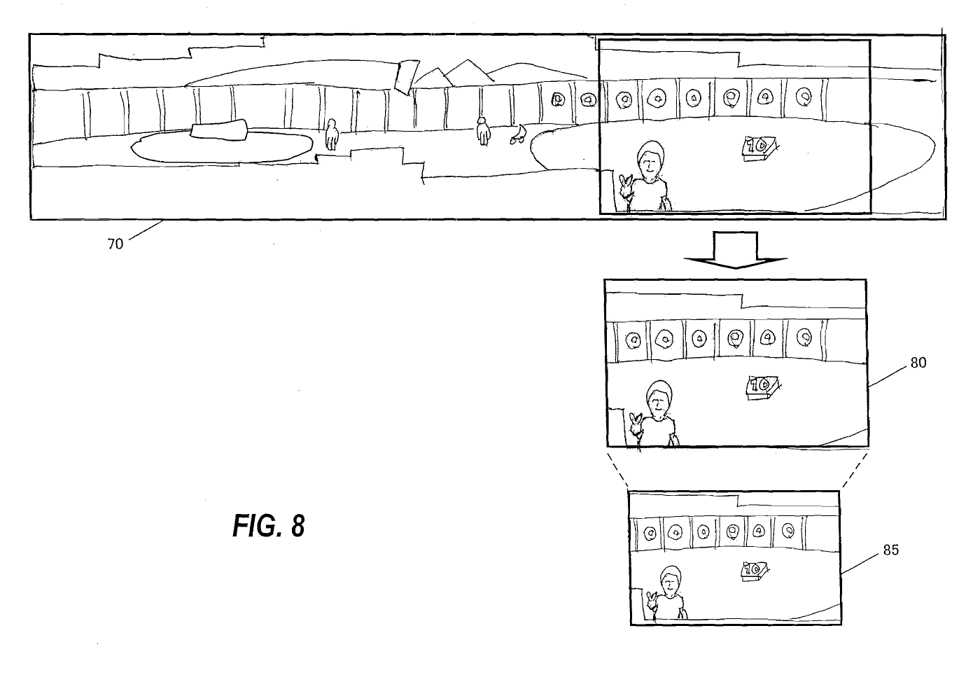

FIG. 8 is a view illustrating a method of calculating the latitudinal direction cutout amount to be applied to a panoramic image 70 generated by the image synthesis unit 29. When a latitudinal direction length of the panoramic image generated by the image synthesis unit 29 is WP, a longitudinal direction length thereof is HP, a longitudinal direction display width upon display of the cutout panoramic image is HD, and a latitudinal direction display width thereof is WD, a latitudinal direction cutout amount WP_NEW of the cutout panoramic image is expressed by a following Equation (1).

WP_NEW=HP×WD/HD (1)

In a step S30, a position of the panoramic image generated by the image synthesis unit 29 on which the user focuses during photography is determined. With respect to the panoramic image generated by the image synthesis unit 29, respective center positions of the plurality of static images used to generate the panoramic image are determined, and a position including the largest number of center positions per unit section in the latitudinal direction of the panoramic image is set as the focus position of the user during moving image photography. Here, the latitudinal direction length WP_NEW upon display of the cutout panoramic image on the display unit 19 is set as the unit section.

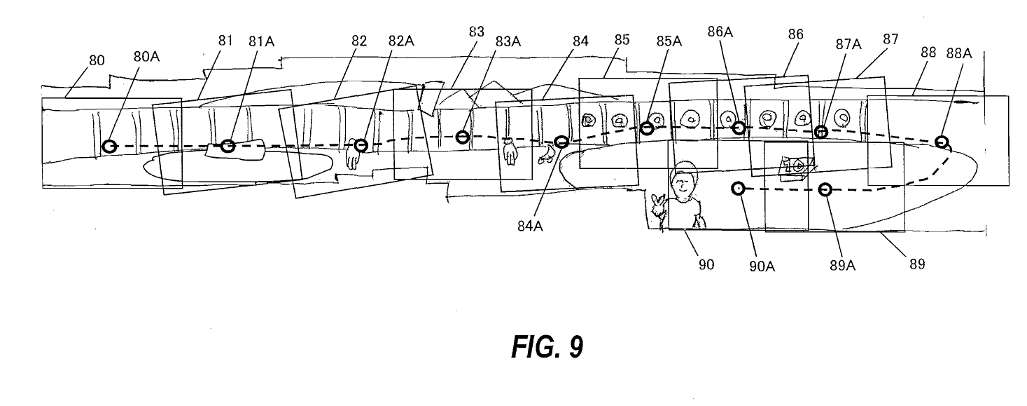

FIG. 9 is a view showing center positions 80A to 90A of a plurality of static images 80 to 90 used to generate a panoramic image, relating to the panoramic image generated by the image synthesis unit 29.

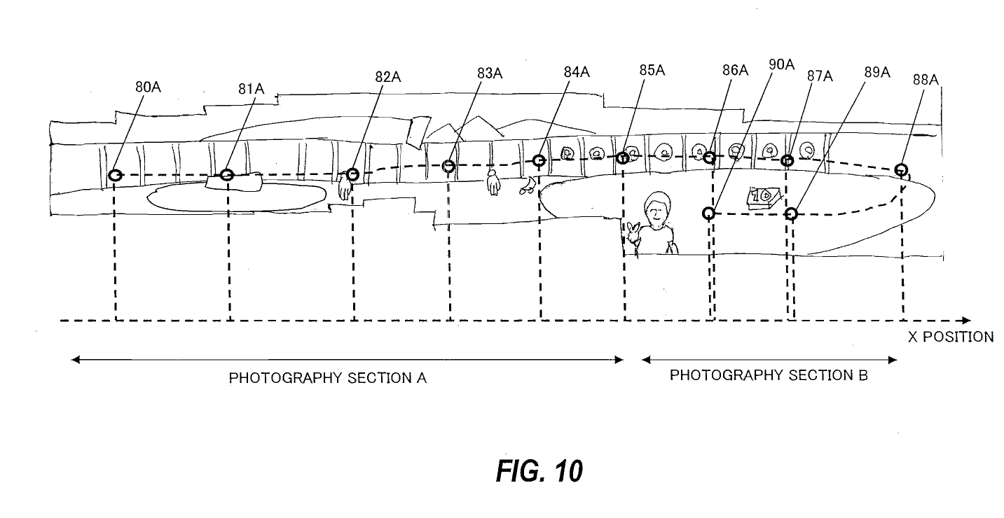

FIG. 10 is a view showing coordinates on an X-axis of the center positions 80A to 90A of the plurality of static images 80 to 90 constituting the panoramic image.

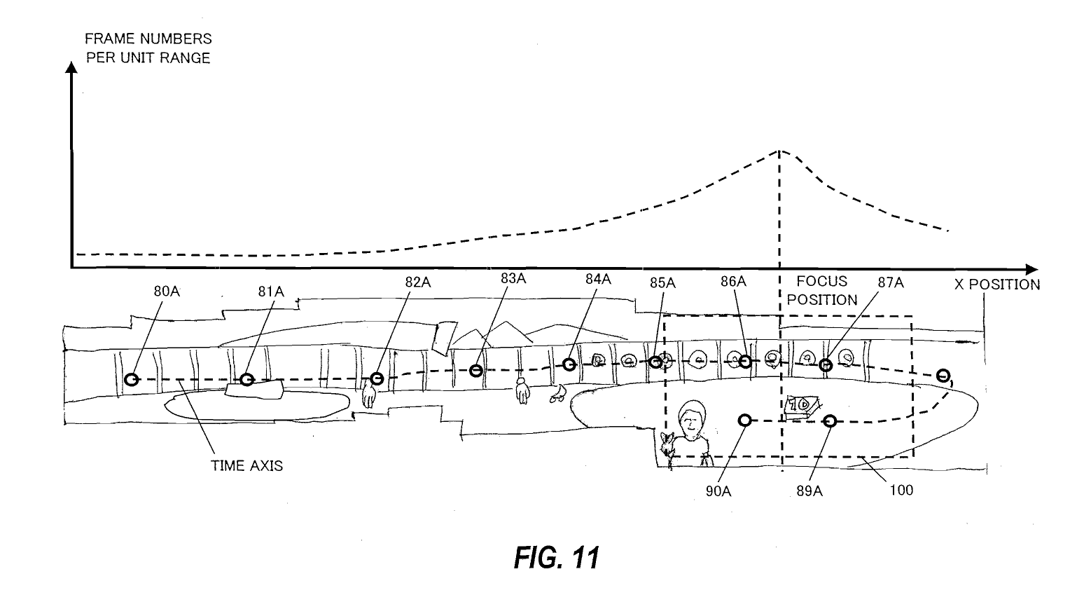

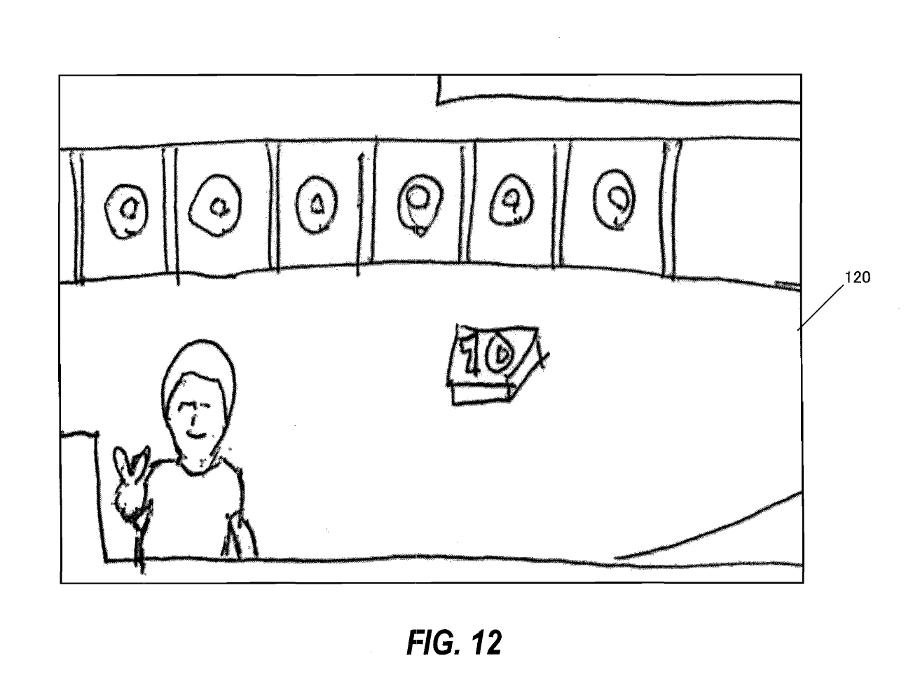

FIG. 11 is a graph showing the number of static image center positions per unit section in the latitudinal direction of the panoramic image, and a view showing a focus position (a focus photography position) of the panoramic image.

It can be seen from the example shown in FIG. 10 that during moving image photography, the user simply moves the camera lens in the latitudinal direction (a rightward direction) in a photography section A, but moves the camera lens in a leftward direction as well as the rightward direction in a photography section B to ensure that the object is photographed thoroughly.

Further, during moving image photography, a photography speed at which the user photographs the focus object is typically slower than a photography speed at which the user photographs an object of less interest.

In other words, a position in which the number of static image center positions per unit section in the latitudinal direction of the panoramic image is large corresponds to a position of an object appearing on the largest number of static images from among the plurality of static images constituting the moving image, and therefore this position may be determined as the focus position of the user. Hence, in the digital camera 1 according to this embodiment, the position including the largest number of static image center positions per unit section in the latitudinal direction of the panoramic image is set as the focus position of the user.

In a step S40 of the flowchart shown in FIG. 4, a determination is made as to whether or not a cutout region generated when an image region corresponding to the cutout amount WP_NEW calculated in the step S20 and centering on the focus position determined in the step S30 is cut out of the panoramic image extends beyond the panoramic image in the latitudinal direction. When it is determined that the cutout region does not extend beyond the panoramic image in the latitudinal direction, the routine advances to the step S60, and when the cutout region extends beyond the panoramic image, the routine advances to a step S50.

In the step S50, the focus position determined in the step S30 is offset by an amount corresponding to the amount by which the cutout region extends beyond the panoramic image so that the cutout region does not extend beyond the panoramic image.

In the step S60, the image region corresponding to the cutout amount WP_NEW calculated in the step S20 and centering on the focus position determined in the step S30 or S50 is cut out of the panoramic image. A region 100 indicated by dotted lines in FIG. 11 is an example of the region cut out of the panoramic image. Further, the image 80 in FIG. 8 is an example of an image cut out of the panoramic image 70, and corresponds to the region 100 indicated by dotted lines in FIG. 11.

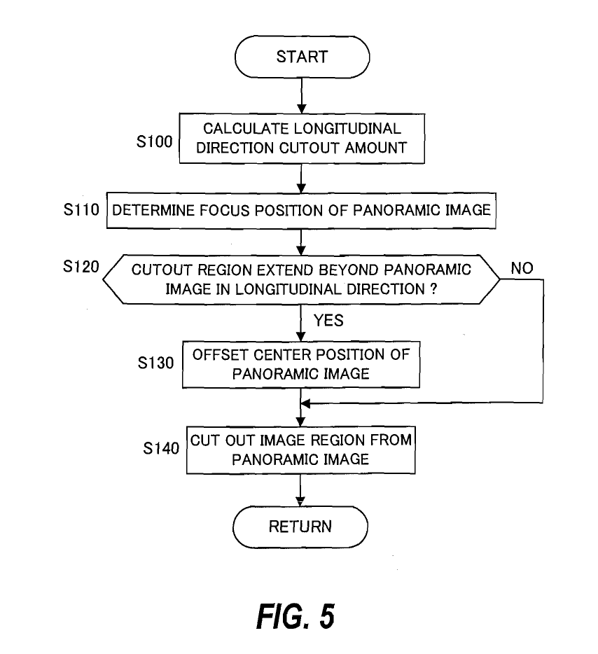

When it is determined in the step S10 that the generated panoramic image is in portrait format, on the other hand, the routine advances to a step S90. In the step S90, processing is performed to cut out an image including the focus object of the user from the portrait shaped panoramic image. This processing will now be described in detail using FIG. 5.

In a step S100 of the flowchart shown in FIG. 5, a longitudinal direction (vertical direction) cutout amount to be applied to the panoramic image generated by the image synthesis unit 29 is calculated. When the latitudinal direction length of the panoramic image generated by the image synthesis unit 29 is WP, the longitudinal direction length thereof is HP, the longitudinal direction display width upon display of the cutout panoramic image is HD, and the latitudinal direction display width thereof is WD, a longitudinal direction cutout amount HP_NEW of the cutout panoramic image is expressed by a following Equation (2).

HP_NEW=WP×HD/WD (2)

In a step S110, the position of the panoramic image generated by the image synthesis unit 29 on which the user focuses during photography is determined. With respect to the panoramic image generated by the image synthesis unit 29, the respective center positions of the plurality of static images constituting the panoramic image are determined, and a position including the largest number of center positions per unit section in the longitudinal direction of the panoramic image is set as the focus position of the user during moving image photography. Here, the longitudinal direction length HP_NEW upon display of the cutout panoramic image on the display unit 19 is set as the unit section.

In a step S120, a determination is made as to whether or not a cutout region generated when an image region corresponding to the cutout amount HP_NEW calculated in the step S100 and centering on the focus position determined in the step S110 is cut out of the panoramic image extends beyond the panoramic image in the longitudinal direction. When it is determined that the cutout region does not extend beyond the panoramic image in the longitudinal direction, the routine advances to a step S140, and when the cutout region extends beyond the panoramic image, the routine advances to a step S130.

In the step S130, the focus position determined in the step S110 is offset by an amount corresponding to the amount by which the cutout region extends beyond the panoramic image so that the cutout region does not extend beyond the panoramic image.

In the step S140, the image region corresponding to the cutout amount HP_NEW calculated in the step S100 and centering on the focus position determined in the step S110 or S130 is cut out of the panoramic image. Once the processing of the step S140 has been performed, the routine advances to a step S70 of the flowchart shown in FIG. 4.

In the step S70, the image cut out in the step S60, or the step S140 of FIG. 5, or in other words the cutout panoramic image, is enlarged/reduced in accordance with a display size of the display unit 19. An expansion/compression coefficient k used when enlarging/reducing the cutout panoramic image is expressed by a following Equation (3).

k=HD/HP (3)

In a step S80, the cutout panoramic image enlarged or reduced in the step S70 is displayed on the display unit 19. An image 85 shown in FIG. 8 is an example of an image obtained by enlarging/reducing the image 80 cut out of the panoramic image 70 in accordance with the expansion/compression coefficient k.

FIG. 12 is a view showing an example of the cutout panoramic image generated from the moving image shown in FIG. 6 and displayed on the display unit 19, this image corresponding to the image 85 of FIG. 8. In a conventional method of generating a panoramic image from a moving image, an excessively landscape shaped image, such as that shown in FIG. 7, or an excessively portrait shaped image is generated, and as a result, the object displayed on the display unit 19 decreases in size, becoming more difficult for the user to view. Further, on a panoramic image such as that shown in FIG. 7, the focus part of the user is difficult to perceive from the entire image. With the panoramic image generation device according to this embodiment, however, as shown in FIG. 12, a panoramic image is generated by cutting out the image region assumed to be the focus of the user, and therefore a panoramic image corresponding to the photographic intentions of the user can be generated.

### Modified Display Example 1

When reproducing a moving image, photography sections assumed to be the focus of the user during photography may be cut out of all of the sections of the moving image and reproduced. The photography sections assumed to be the focus of the user are sections included in the cutout panoramic image.

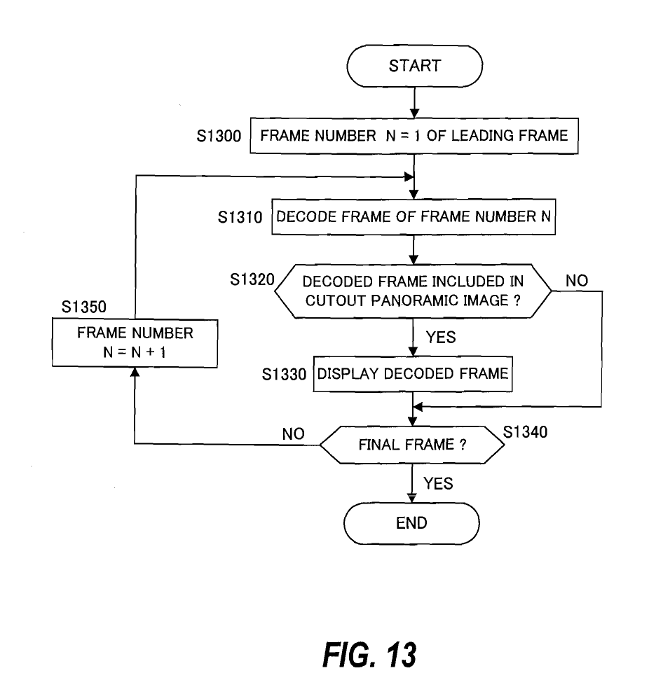

FIG. 13 is a flowchart showing a flow of processing for displaying a moving image using static images included in the cutout panoramic image.

In a step S1300, a frame number N of a leading frame from among a plurality of frames (static images) constituting a moving image is set at 1.

In a step S1310, frame data relating to the frame number N are decoded.

In a step S1320, a determination is made as to whether or not the frame decoded in the step S1310 is included in the cutout panoramic image. Here, a determination is made as to whether or not a center position of the decoded frame is included in the cutout panoramic image.

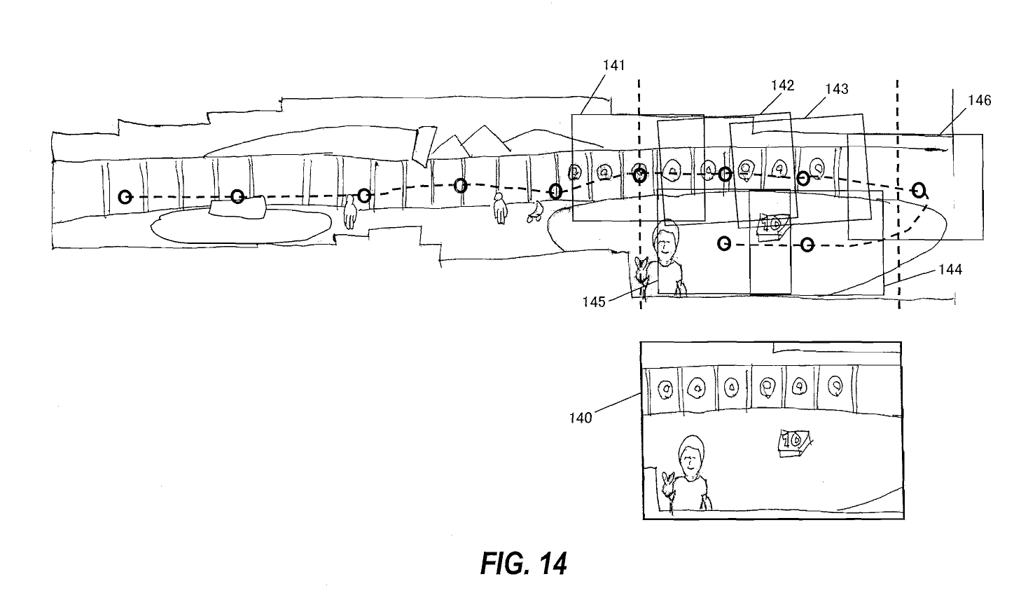

FIG. 14 is a view showing examples of frames 141 to 145 included in a cutout panoramic image 140. As shown in FIG. 14, the center positions of the frames 141 to 145 are included in the cutout panoramic image 140. A frame 146 shown in FIG. 14 is not included in the cutout panoramic image 140.

When it is determined in the step S1320 that the decoded frame is not included in the cutout panoramic image, the routine advances to a step S1340, and when it is determined that the decoded frame is included, the routine advances to a step S1330.

In the step S1330, the frame decoded in the step S1310 is displayed on the display unit 19.

In the step S1340, a determination is made as to whether or not the frame having the frame number N is a final frame of the moving image. When it is determined that the frame having the frame number N is not the final frame of the moving image, the routine advances to a step S1350, where 1 is added to the frame number N. The routine then returns to the step S1310. When it is determined that the frame having the frame number N is the final frame of the moving image, on the other hand, the processing of the flowchart is terminated.

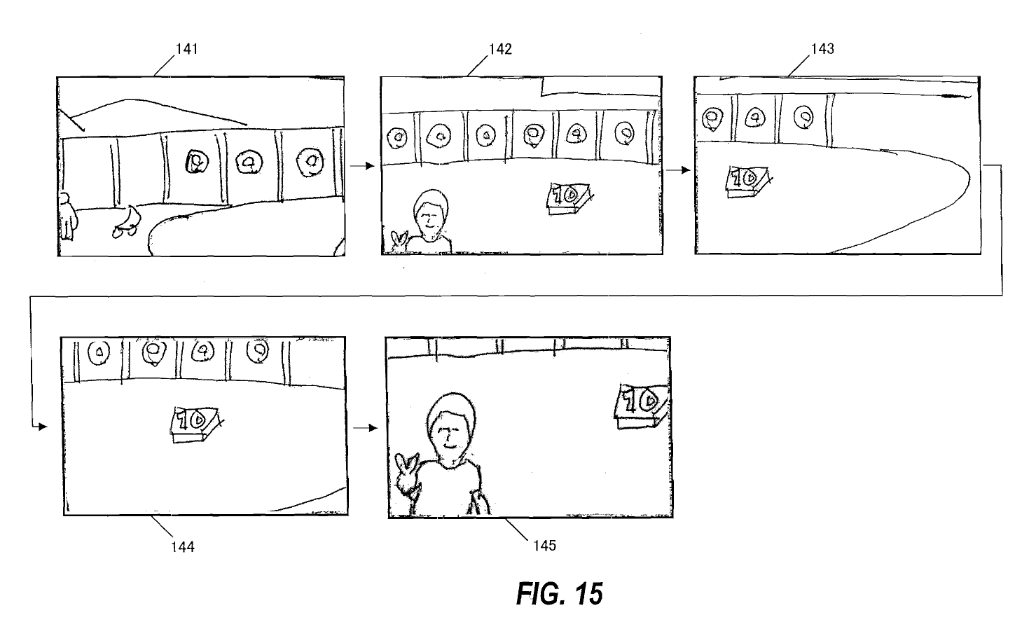

FIG. 15 is a view showing an example in which the frames 141 to 145 included in the cutout panoramic image 140 are reproduced in sequence as a moving image. In this case, the displayed frames are obtained by extracting a part of the plurality of frames constituting the moving image, and therefore an intermediate frame may be missing. According to this moving image display method, however, the photography sections assumed to be the focus of the user during moving image photography can be extracted and reproduced in the form of a digest. Therefore, even when the moving image is photographed over a long period of time, the objects on which the user was focusing during the moving image photography can be viewed efficiently in a short amount of time.

### Modified Display Example 2

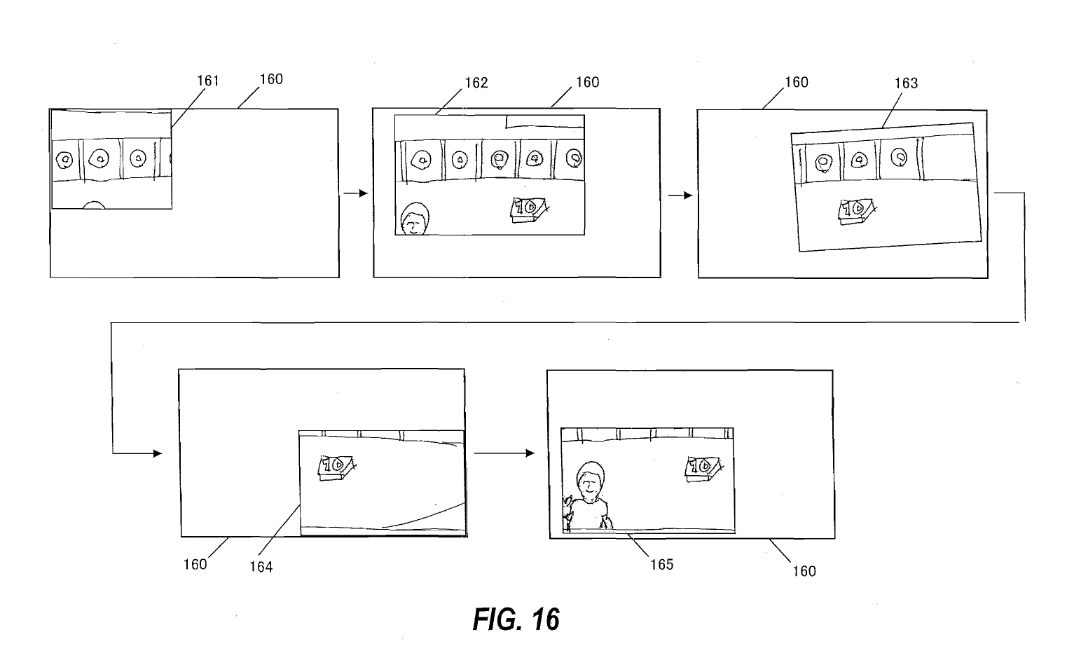

FIG. 16 is a view showing an example in which a cutout panoramic image 160 is displayed simultaneously during reproduction of a moving image in the form of a digest, as described above. In this display method, frames 161 to 165 to be reproduced as a digest are displayed in sequence on the display unit 19 while displaying the cutout panoramic image 160. It should be noted, however, that the frames reproduced as a digest are emphasized in order to differentiate them from the cutout panoramic image displayed in the background.

In the example shown in FIG. 16, the frames 161 to 165 reproduced as a digest are emphasized by reducing a luminance of image regions of the cutout panoramic image 160 other than the image region reproduced as a digest. However, the method of emphasizing the frames reproduced as a digest is not limited to this method. For example, the frames reproduced as a digest may be emphasized by displaying a frame edge of the reproduced frames.

With this moving image display method, it is easy to recognize the section that is being reproduced from among the photographed moving image sections.

### Modified Display Example 3

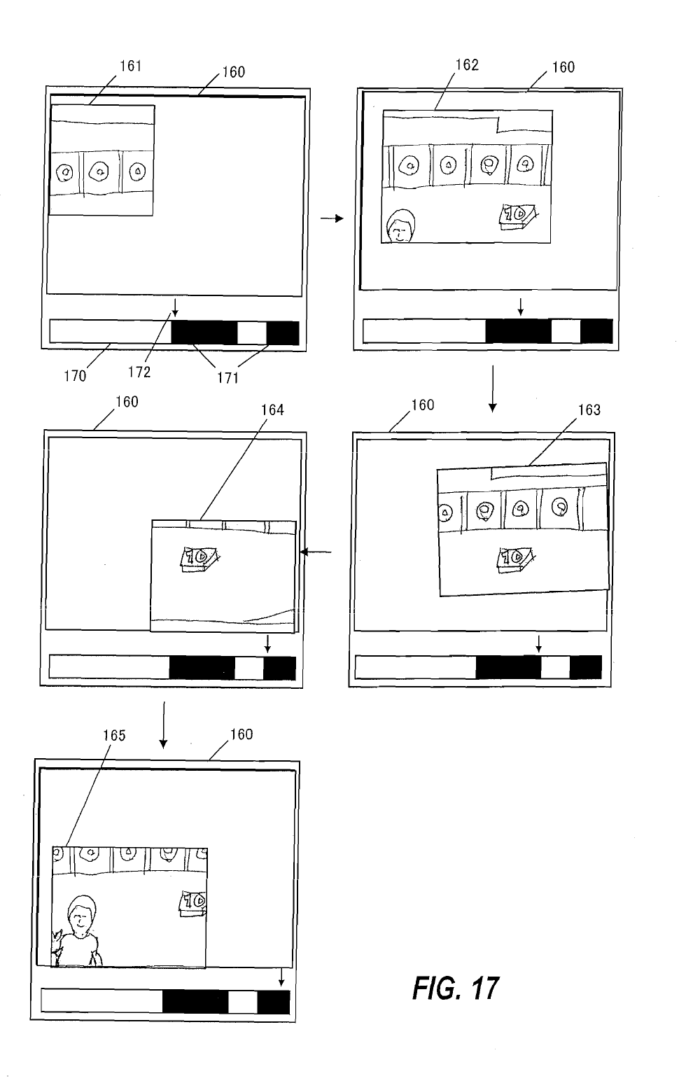

FIG. 17 is a view showing an example in which a time bar 170 is displayed additionally in the moving image reproduction method described using FIG. 16. A length of the time bar 170 corresponds to a length of the entire photographed moving image section, and black sections 171 correspond to the moving image sections reproduced as a digest. Further, arrows 172 indicate positions of frames currently being reproduced as a digest from the entire photographed moving image section. Thus, the section that is being reproduced from the entire photographed moving image section can be recognized easily.

The length of the time bar may be set to correspond to the length of the photography section of the cutout panoramic image. In this case, it is possible to confirm the section that is being reproduced as a digest from the photography section of the cutout panoramic image.

To perform display in the manner described above, data indicating the cutout panoramic image and reproduction positions of the moving image are attached to data relating to the moving image using the static images included in the cutout panoramic image and stored together therewith in the storage unit 20. As a result, a moving image having the cutout panoramic image in the background and a moving image showing the reproduction position of the moving image within the panoramic image, such as that shown in FIG. 17, can be displayed easily.

### Modified Display Example 4

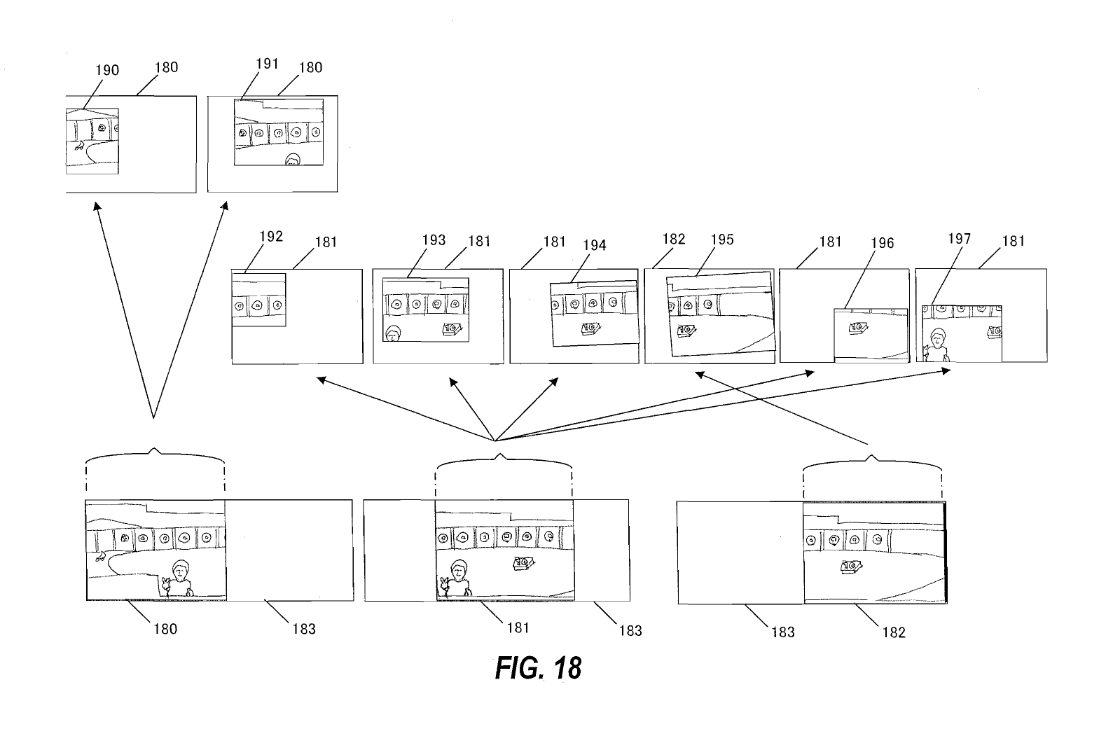

In the moving image reproduction method described using FIG. 16, the cutout panoramic image displayed on the display unit 19 does not move. FIG. 18 is a view showing an example in which the cutout panoramic image displayed on the display unit 19 also moves.

In the display example shown in FIG. 18, the cutout panoramic image displayed on the display unit 19 is switched sequentially to an image 180, an image 181, an image 182, and the image 181. In FIG. 18, an upper section shows a transition of the screen displayed on the display unit 19, while a lower section shows the cutout panoramic images displayed together with frames 190 to 197 reproduced as a digest. In the lower section of FIG. 18, an image 183 displayed together with the cutout panoramic images 180, 181, 182 is an image representing a part of the panoramic image constituted by the plurality of static images forming the moving image, and this image is displayed to make it easier to recognize relationships between the respective cutout panoramic images 180 to 182.

The cutout panoramic image 181 is a cutout panoramic image generated using the method described above. The cutout panoramic image 180 is a panoramic image obtained by cutting out a part of the image 183 having an earlier photography time than the cutout panoramic image 181. For example, the panoramic image 180 is cut out from the image 183 so that a left half of the cutout panoramic image 181 and a right half of the cutout panoramic image 180 include an identical object. However, when cutting out the cutout panoramic image 180 from the image 183, any part having an earlier photography time than the cutout panoramic image 181 may be cut out as desired.

The cutout panoramic image 182 is a panoramic image obtained by cutting out a part of the image 183 having a later photography time than the cutout panoramic image 181. For example, the panoramic image 182 is cut out from the image 183 so that a right half of the cutout panoramic image 181 and a left half of the cutout panoramic image 182 include an identical object. However, when cutting out the cutout panoramic image 182 from the image 183, any part having a later photography time than the cutout panoramic image 181 may be cut out. The cutout panoramic images 180, 181, 182 are identically sized.

The frames to be reproduced as a digest-type moving image are the frames included in the cutout panoramic images 180, 181, 182. In the example shown in FIG. 18, frames 190 to 197 serve as the frames to be reproduced as a digest-type moving image.

Of the frames 190 to 197 to be reproduced as a digest, the frames 190, 191 are images included in the cutout panoramic image 180, and are displayed together with the cutout panoramic image 180. Further, the frames 192, 193, 194, 196, 197 are images included in the cutout panoramic image 181, and are displayed together with the cutout panoramic image 181. Furthermore, the frame 195 is an image included in the cutout panoramic image 182, and is displayed together with the cutout panoramic image 182. Hence, when the frame 192 is to be displayed from a state in which the frame 191 is displayed, the cutout panoramic image displayed simultaneously switches from the image 180 to the image 181. Similarly, when the frame 196 is to be displayed from a state in which the frame 195 is displayed, the cutout panoramic image displayed simultaneously switches from the image 182 to the image 181.

According to this display method, it is possible to perform digest-type moving image reproduction in relation to a wider photography range than that of a display method using a single cutout panoramic image.

It should be noted that the cutout panoramic images displayed together with the frames may be prepared in a large number such that the large number of displayed cutout panoramic images are switched little by little. In so doing, display can be performed such that the cutout panoramic image displayed in the background varies little by little.

With the panoramic image generation device according to the embodiment described above, a panoramic image is generated by synthesizing a plurality of static images constituting a moving image, the size at which the display panoramic image is to be cut out from the generated panoramic image is determined, and the focus photography position is detected from the generated panoramic image. The display panoramic image is then cut out from the panoramic image on the basis of the detected focus photography position and the determined size. As a result, it is possible to generate a panoramic image on which the focus object of the user can be recognized easily.

Further, the position of an object appearing on the largest number of static images from the plurality of static images constituting the moving image is detected on the panoramic image generated from the plurality of static images constituting the moving image as the focus photography position. Thus, the position assumed to be the focus of the user during moving image photography can be detected with a high degree of precision, and as a result, it is possible to generate a panoramic image on which the focus object of the user can be recognized easily.

Furthermore, by performing moving image reproduction using the static images included in the display panoramic image, from among the plurality of static images constituting the moving image, the photography section assumed to be the focus of the user during moving image photography can be extracted, and the moving image can be reproduced as a digest.

Moreover, during reproduction of the moving image using the static images included in the display panoramic image, the moving image is emphasized while the display panoramic image is displayed in the background. In so doing, the user can recognize the section that is being reproduced, from among the photographed moving image sections, easily.

Further, with the panoramic image generation device according to this embodiment, the reproduction position on at least one of the panoramic image generated by synthesizing the plurality of static images constituting the moving image and the display panoramic image can be displayed during reproduction of the moving image using the static images included in the display panoramic image. As a result, the user can recognize the section that is being reproduced, from among the photographed moving image sections, easily during moving image reproduction.

The display panoramic image and data indicating the reproduction position of the moving image are attached to and stored together with data relating to the moving image using the static images included in the display panoramic image, and therefore the moving image using the static images included in the display panoramic image can be reproduced easily with the display panoramic image displayed in the background. Furthermore, during reproduction of the moving image using the static images included in the display panoramic image, the reproduction position of the moving image on the panoramic image can be displayed easily.

Moreover, with the panoramic image generation device according to this embodiment, a plurality of display panoramic images may be prepared, and when the moving image using the static images included in the display panoramic image is reproduced with the display panoramic image in the background, the display panoramic image may be switched in accordance with reproduction of the moving image. Thus, moving image reproduction can be performed in relation to a wider photography range than that of a display method employing a single display panoramic image.

In the above description of the embodiment, it is assumed that the processing performed by the panoramic image generation device is hardware processing, but this invention need not be limited to such a constitution. For example, a constitution in which the processing is performed by software may be employed. In this case, a computer includes a CPU, a main storage device such as a RAM, and a computer-readable storage medium storing a program for realizing all or a part of the processing described above. Here, the program is referred to as a panoramic image generation program. By having the CPU read the panoramic image generation program stored on the storage medium and execute information processing/calculation processing, similar processing to that of the panoramic image generation device described above is realized.

Here, a computer-readable storage medium denotes a magnetic disk, a magneto-optical disk, a CD-ROM, a DVD-ROM, a semiconductor memory, and so on. Further, the panoramic image generation program may be distributed to the computer by a communication line, whereupon the computer executes the received distributed panoramic image generation program.

This invention is not limited to the embodiment described above, and may be subjected to various amendments and applications within a scope that does not depart from the spirit of the invention. For example, the camera installed with the panoramic image generation device is described as a digital camera, but a moving image camera such as a video camera or a movie camera, or a camera built into a portable telephone, a portable information terminal (a PDA: Personal Digital Assistant), a game device, or the like, may be used instead.

In the embodiment described above, as shown in FIG. 11, the position (a peak position) including the largest number of static image center positions per unit section in the latitudinal direction (or the longitudinal direction) of the panoramic image is set as the focus photography position. Here, when a plurality of peak positions exist on a graph of the number of static image center positions per unit section, a peak position in which the number of static image center positions per unit section per unit section equals or exceeds a predetermined threshold may be set as the focus photography position. When a plurality of set focus photography positions exist, a cutout panoramic image is generated for each of the set focus photography positions.

This application claims priority based on JP2010-245195, filed with the Japan Patent Office on Nov. 1, 2010, the entire contents of which are incorporated into this specification by reference.

What is claimed is:

1. A panoramic image generation device capable of generating a panoramic image from a moving image, comprising:
a panoramic image generation unit that generates the panoramic image by synthesizing a plurality of static images constituting the moving image;
a cutout size determination unit that determines a size at which a display panoramic image is to be cut out from the panoramic image generated by the panoramic image generation unit;
a focus photography position determination unit that detects a focus photography position from the panoramic image generated by the panoramic image generation unit;
a display panoramic image cutout unit that cuts out the display panoramic image from the panoramic image generated by the panoramic image generation unit on the basis of the focus photography position detected by the focus photography position determination unit and the size determined by the cutout size determination unit; and
a display unit that displays the display panoramic image cut out by the display panoramic image cutout unit.

2. The panoramic image generation device as defined in claim 1, wherein the focus photography position determination unit detects a position of an object appearing on a largest number of static images, from among the plurality of static images constituting the moving image, on the panoramic image generated by the panoramic image generation unit as the focus photography position.

3. The panoramic image generation device as defined in claim 1, further comprising a reproduction unit that performs moving image reproduction using the static images included in the display panoramic image, from among the plurality of static images constituting the moving image.

4. The panoramic image generation device as defined in claim 3, wherein, during reproduction of the moving image using the static images included in the display panoramic image, the reproduction unit performs reproduction such that the moving image is emphasized while the display panoramic image is displayed as a background.

5. The panoramic image generation device as defined in claim 3, wherein, during reproduction of the moving image using the static images included in the display panoramic image, the display unit performs display indicating a reproduction position on at least one of the panoramic image generated by the panoramic image generation unit and the display panoramic image cut out by the display panoramic image cutout unit.

6. The panoramic image generation device as defined in claim 5, further comprising a storage unit that stores data indicating the display panoramic image and the reproduction position of the moving image in association with data relating to the moving image using the static images included in the display panoramic image.

7. The panoramic image generation device as defined in claim 4, wherein the display panoramic image cutout unit cuts out a plurality of display panoramic images, and
when the reproduction unit reproduces the moving image using the static images included in the display panoramic image with the display panoramic image as the background, the reproduction unit switches the display panoramic image in accordance with reproduction of the moving image.

8. A panoramic image generation method for generating a panoramic image from a moving image, comprising:
a step of generating the panoramic image by synthesizing a plurality of static images constituting the moving image;
a step of determining a size at which a display panoramic image is to be cut out from the generated panoramic image;
a step of detecting a focus photography position from the generated panoramic image; and
a step of cutting out the display panoramic image from the panoramic image on the basis of the detected focus photography position and the determined size.
